(19) United States
(12) Patent Application Publication
(10) Pub. No.: US 2005/0229005 A1
(43) Pub. Date: Oct. 13, 2005

(54) Security badge arrangement

(75) Inventors: Eric F. Le Saint, Los Altos, CA (US); Dominique Louis Joseph Fedronic, Belmont, CA (US)

Correspondence Address: STEVENS DAVIS MILLER & MOSHER, LLP, 1615 L STREET, NW, SUITE 850, WASHINGTON, DC, 20036, US

(73) Assignee: ACTIVCARD Inc., Fremont, CA (US)

(21) Appl. No.: 10/819,131

(22) Filed: Apr. 7, 2004

(51) Int. Cl. G06F 7/00

(52) U.S. Cl. 713/185; 726/9

(57) ABSTRACT

A method and computer program product which comprises storing at least one data file inside a portable device such as security token or flash memory drive associated with a security badge. The data file includes sufficient information to allow a third party to verify the identity of an assignee of the security badge. The identity of the assignee is based at least in part on the information included in the data file by the third party without having to rely on a presentation affixed to one or more exterior surfaces of the security badge. Other embodiments of the invention comprises operatively coupling the security token to a security system, authenticating the assignee to the security token, generating a digital signature of the data file using a private key, and sending the digital signature, the data file and a digital certificate associated with the private key to said security system. The sufficient information comprises a digital photograph of the assignee, the assignee's name, the assignee's employer name, a logo of the employer or a security badge number and instructions for reading the data file when provided in a proprietary format. Final verification of the assignee's identity is performed by a security officer.

### FIELD OF INVENTION

The present invention relates generally to a data processing method, and more specifically to a method which allows the identity of an assignee to be verified using a security system of another entity.

### BACKGROUND

Security badges which incorporate a security token are becoming increasingly popular for corporate, financial and governmental identification purposes. In a typical enterprise deployment, the security badges include a company logo, a company name, an employee or badge number, an employee name and a photograph of the employee imprinted on the exterior of the badge.

This arrangement, while useful, does not generally combine the logical security available from the security token with physical and/or financial security provided by a security officer who is responsible for correctly identifying the holder of the security badge. In many instances, the information provided on the exterior of the security badge is not stored or bound to information securely stored inside the security token.

As such, a lost or stolen security badge could easily be altered to include a photograph of an attacker. Likewise, a security badge could easily be forged based on visual observation of an authentic security badge. Unless the security officer is personally familiar with the individual, it is likely that an attacker would slip through a security checkpoint.

However, even if some of the identity information is stored inside the security token, an additional impediment is created by the lack of standards available to allow the interoperability of the identity information stored inside a security token outside the security systems in which it was originally intended.

Therefore, a mechanism which facilitates interoperability of identity information stored inside a security token and further facilitates identification without having to rely on easily altered imprinting and/or embossing of a security badge is highly desirable.

### SUMMARY

This invention addresses the limitations described above and provides a mechanism which facilitates the interoperability of identity information stored inside a security token associated with a security badge and further facilitates identification without having to rely on easily altered imprinting and/or embossing of the security badge is highly desirable.

The term “security token” as described herein includes hardware based security devices such as cryptographic modules, smart cards, integrated circuit chip cards, portable data carriers (PDC), personal security devices (security token), subscriber identification modules (SIM), wireless identification modules (WIM), USB token dongles and like devices.

The term “portable device” as described herein includes the security token as described above and adds a portable flash memory device such as a flash memory drive.

The term “security badge” as is described herein refers to a physical card or card like object having a use in identifying the holder of the card or card like object which is coupled to or otherwise associated with a security token as described above. Typical examples of which include smart cards assigned to a person by an organization for both physical and logical security purposes and credit cards used in financial services which incorporate a security token. The terms security token and security badge may be used interchangeably herein.

The term “security officer” as is described herein refers to an individual whose is assigned the responsibility of properly identifying a holder of a security badge for security or financial transaction purposes.

In a first method embodiment, the invention comprises storing at least one data file inside a portable device such as a security token or portable flash memory device associated with a security badge and verifying the identity of the assignee based at least in part on the information included in the data file. The data file includes sufficient information to allow a third party to verify the identity of an assignee of the security badge without having to rely on a presentation such as a photograph of the assignee affixed to one or more exterior surfaces of the security badge. The assignee's identification is accomplished in one inventive embodiment by operatively coupling the portable device to a security system, authenticating the assignee to the portable device, generating a digital signature of the data file using a private key, and sending the digital signature, the data file and a digital certificate associated with the private key to the security system.

In another inventive embodiment, the security system verifies the digital certificate using a certificate authority associated with the digital certificate, and further verifies the digital signature with a public key included in the digital certificate.

Examples of information sufficient to verify the identity of the assignee comprises a digital photograph of the assignee, the assignee's name, the assignee's employer name, a logo of the employer, a security badge number, a web address of a host entity server (URL) or a transferable application which is executable on the security system. In a further embodiment of the invention, additional information is provided to the security system in the form of executable instructions sufficient to permit the security system to at least display the contents of the data file to the third party in a usable format.

In one embodiment of the invention, the assignee is required to authenticate to the portable device before the data file is sent to the security system by the assignee inputting a critical security parameter into the security token via the security system.

Typically, this involves entry of a personal identification number (PIN) into a card reader or key board coupled to the security system. The identity of the assignee is accomplished by a security officer visually observing the assignee and the displayed contents of the data file, which generally is a digital photograph of the assignee.

In an embodiment of the invention, the information for usefully displaying the contents of the data file is extrinsic to the data file. Typically, the data file is of a proprietary type which requires sending formatting and positioning information to the security system to properly display the identifying information used to verify the identity of the assignee. In another embodiment of the invention, the information for usefully displaying the contents of the data file is intrinsic to the data file. Typically, the data file is formatted in a standard image format which is recognized by the security system based on the file extension. For example, file extensions having *.bmp, *.tif, *.pdf, *.jpg, *.wmf, etc., are generally recognized automatically by the operating system associated with the security system and no special formatting or positioning information is required to be included with the data file.

In a second method embodiment, the invention comprises operatively coupling a portable device associated with a security badge and an assignee to a security system, providing assignee identity information to the security system, providing sufficient executable instructions for reading the assignee identity information by the security system to at least display the assignee identity information to a third party in a usable format, reading the assignee identity information using the provided sufficient instructions, and visually verifying the identity of the assignee based at least in part on the provided assignee identity information without having to rely on a presentation affixed to one or more exterior surfaces of the security badge.

In another embodiment of the invention, verifying the assignee identity information is accomplished using at least one common public key infrastructure transaction, for example verifying a digital signature using a public key supplied in a digital certificate or verifying the digital certificate using a certificate authority.

A computer program product embodiment of the invention is provided which incorporates the first or second method embodiments of the invention in a tangible form having instructions executable by at least one processor stored thereon. The tangible form includes magnetic media, optical media or logical media. The stored instructions executable by the at least one processor are stored in a code format comprising byte code, compiled, interpreted, compliable and interpretable.

### BRIEF DESCRIPTION OF DRAWINGS

The features and advantages of the invention will become apparent from the following detailed description when considered in conjunction with the accompanying drawings. Where possible, the same reference numerals and characters are used to denote like features, elements, components or portions of the invention. Optional components are generally shown in dashed lines. It is intended that changes and modifications can be made to the described embodiment without departing from the true scope and spirit of the subject invention as defined in the claims.

FIG. 1—is a generalized block diagram of a computer system and associated peripheral devices including a functionally connected security token.

FIG. 2—is a detailed block diagram of an embodiment of the invention where a security token is operatively coupled to a security computer system.

FIG. 2A—is a detailed block diagram of an embodiment of the invention where a transfer of security information is performed.

FIG. 2B—is a detailed block diagram of an embodiment of the invention where the security information is validated.

FIG. 2C—is a detailed block diagram of an alternate embodiment of the invention where the portable device is a flash memory based device.

FIG. 3—is a detailed block diagram of an embodiment of the invention where the validated security information is displayed for authorization by a security officer.

FIG. 4—is a detailed block diagram of an embodiment of the invention which provides an example of how reading instructions may be interpreted by a security system.

FIG. 5—is a flow diagram illustrating the major steps associated with implementing an embodiment of the invention.

### DETAILED DESCRIPTION

This present invention provides a mechanism to authorize a generally unaffiliated person using security information stored inside the person's security token. The security information may optionally include instructional information necessary for the security system to use and display the security information if provided in an unknown or proprietary format. Where necessary, applications used to implement the various embodiments of the invention are envisioned to be programmed in a high level language such as Java™, C++, and C, C # or Visual Basic™.

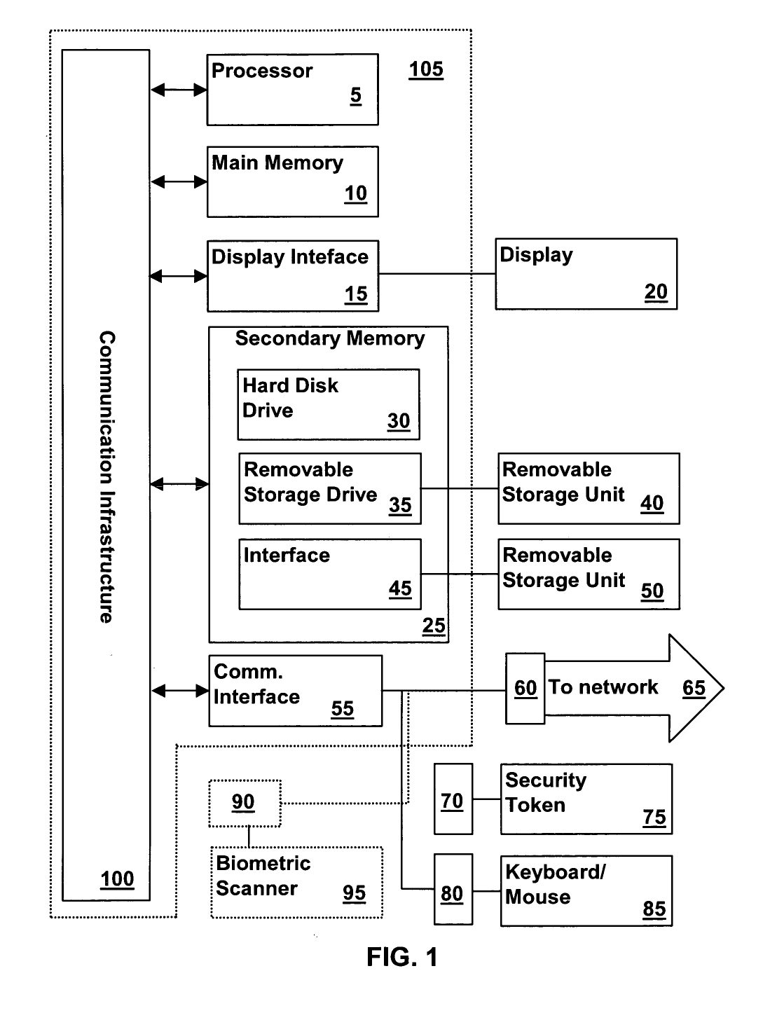

Referring to FIG. 1, a functional block diagram of a computer system 105 and associated peripherals is depicted. In a networking environment, the depicted computer system 105 is intended to apply to both client and server arrangements.

The computer system 105 includes a processor 5, a main memory 10, a graphical display 20 electrically coupled to a graphical display interface 15, a secondary memory subsystem 25 electrically coupled to a hard disk drive 30, a removable storage drive 35 electrically coupled to a removable storage unit 40 and an auxiliary removable storage interface 45 electrically coupled to an auxiliary removable storage unit 50. The display device 20 may include a touch sensitive screen. The removable storage units 45, 50 include flash memory devices such as USB based solid state hard drives.

A communications interface 55 subsystem is coupled to a network 65 via a network interface 60. The network 65 includes traditional wired, optical or wireless networks which may incorporate a secure communications protocol such as secure socket layer (SSL), transport layer security (TLS), private communications technology (PCT) or internet protocol security (IPsec.)

A security token 75 is operably coupled to the communications interface 55 via a security token interface 70. The security token 70 may be directly coupled to the computer system 105 or remotely coupled to the computer system 105 via another networked computer system. The security token 75 includes a wireless, optical and/or electrical connection means compatible with the security token interface 70, a microprocessor, a cryptography co-processor, volatile and non-volatile memory electrically coupled to the processor and co-processor, a runtime operating environment, cryptography extensions available to the runtime environment and capable of performing symmetric and asymmetric cryptographic functions compatible with the computer system's and/or an authentication server's cryptography software.

The security token 75 includes in an embodiment of the invention a reference critical security parameter (CSP), an X.509 format digital certificate, at least one asymmetric key pair associated with the digital certificate, security information, security information reading instructions and related applications functionally stored inside the security token 75.

The security token may include printed and/or embossed information associated with an assigned user and issuing entity on one or more exterior surfaces of the security token such as is common in security badge arrangements, however, the printed or embossed information is not required for use in this invention.

User input devices such as a mouse and a keyboard 85 are operatively coupled to the communications interface 55 via a user interface 80. Lastly, a biometric scanner 95 may optionally be coupled to the communications interface 55 via a biometric scanner interface 90.

The processor 5, main memory 10, display interface 15, secondary memory subsystem 25 and communications interface system 55 are electrically coupled to a communications infrastructure 100, commonly known as I/O bus. The computer system 105 includes an operating system, one or more security applications, a security token application programming interface, one or more security token aware applications, cryptography software capable of performing symmetric and asymmetric cryptographic functions compatible with that of the security token 75 and/or an authentication server, at least one graphical display application suitable for displaying the security information received from the security token 75 and all necessary device interface and driver software.

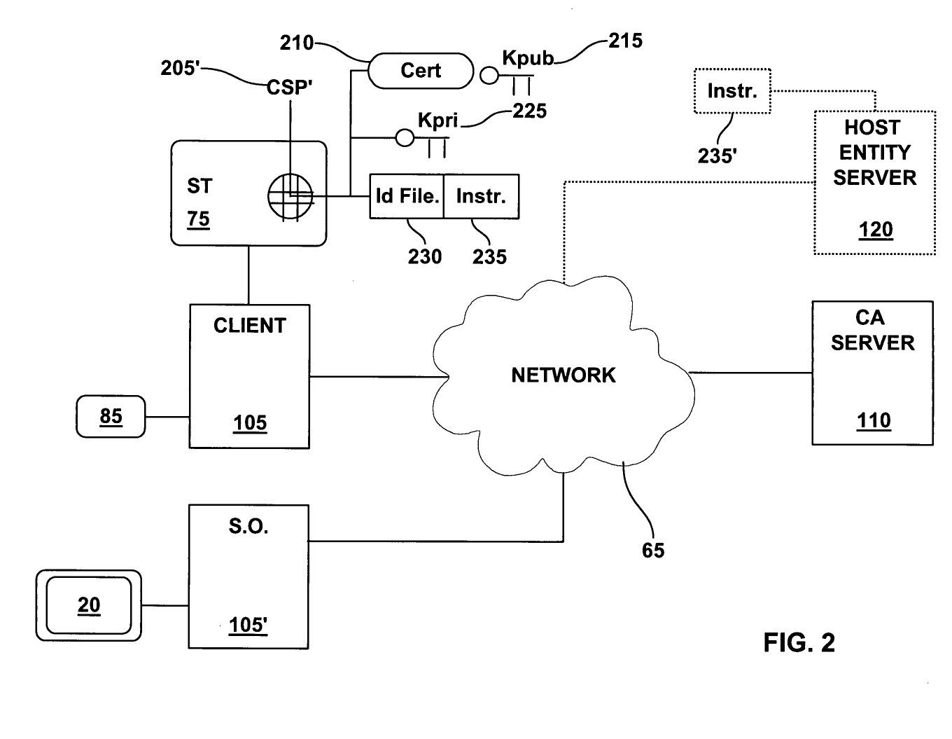

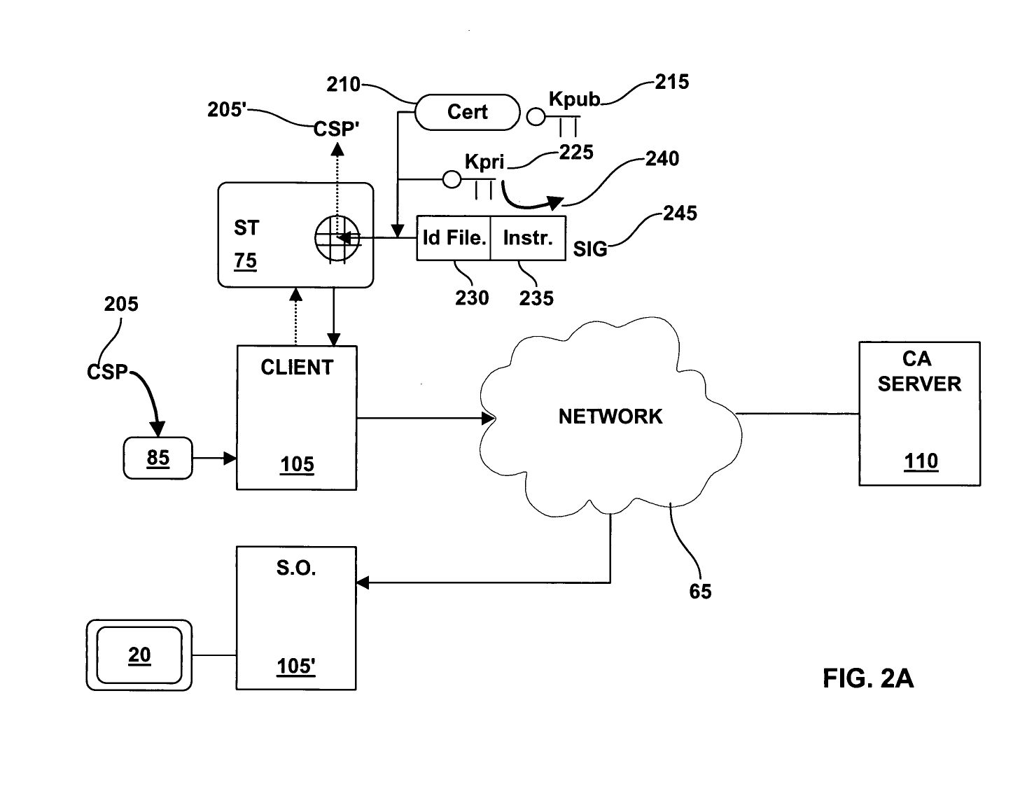

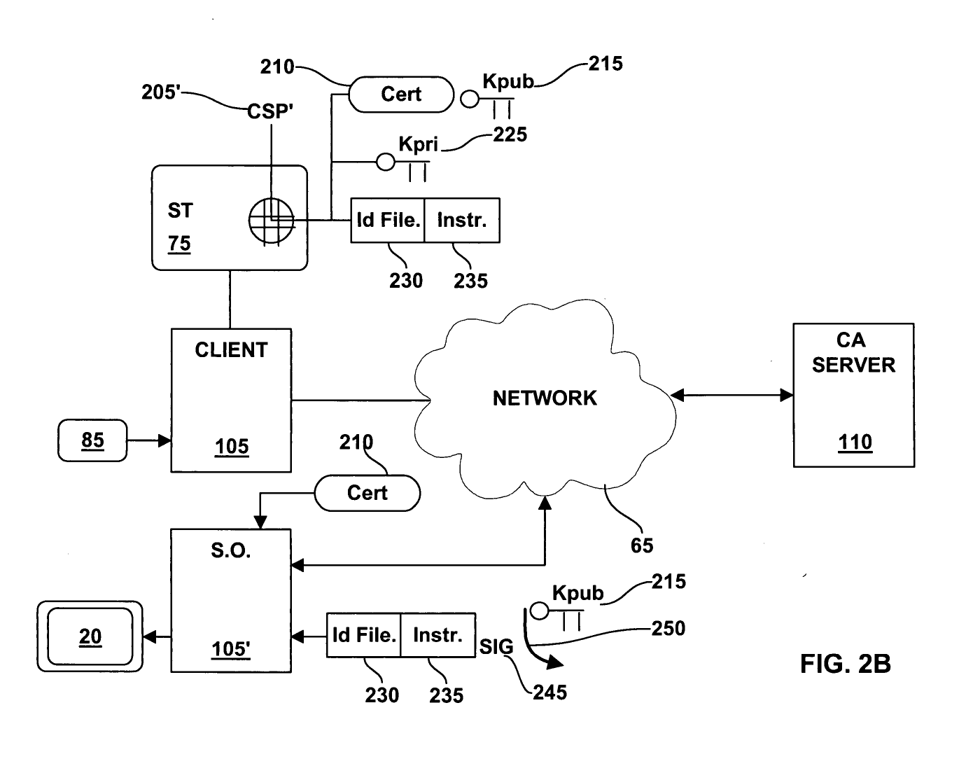

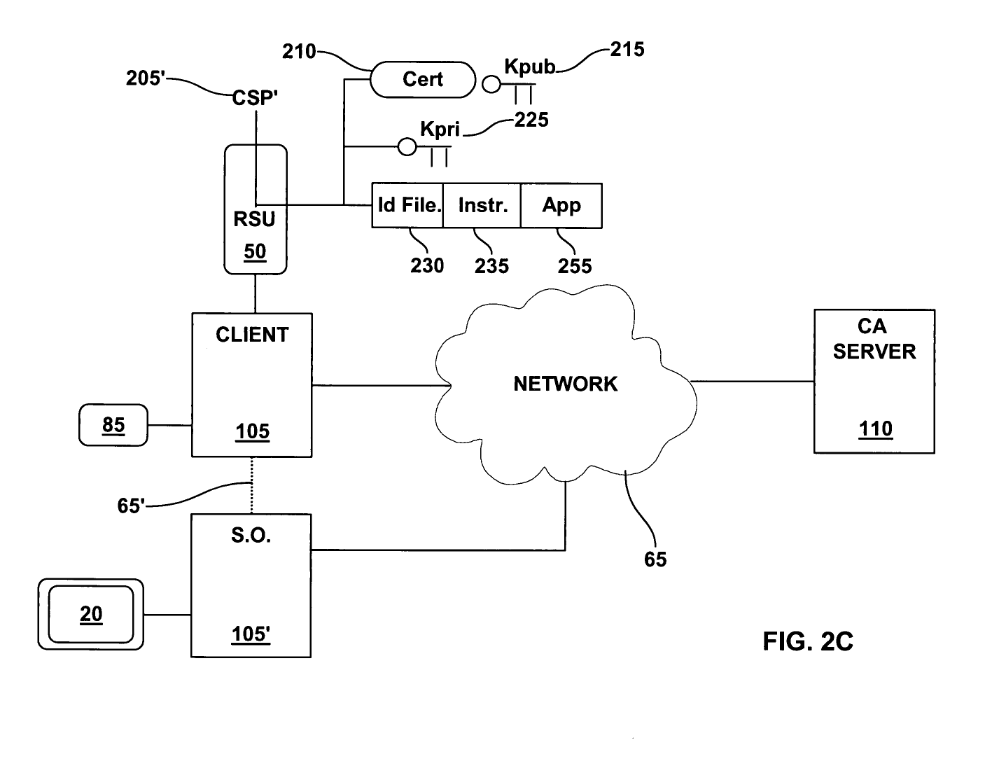

Referring to FIG. 2, a general arrangement of the invention is shown where a computer system CS 105 is coupled to a communications network 65, a user input device 85 and a security token ST 75. The network 65 is coupled to a security officer's computer system S.O. 105′ and a certificate authority CA 110. The security token ST 75 includes a reference critical security parameter CSP′ 205′, a digital certification Cert 210, at least one asymmetric key pair Kpub, Kpri 215, 225 associated with the digital certificate 210, security information stored in an identity file Id File 230 and executable instructions Instr 235 for reading the identity file Id File 230.

The instructions Instr 235 provide sufficient information to the security officer's computer system S.O. 105′ to allow the contents of the identity file Id File 230 to be opened and usefully displayed on a graphical display 20 coupled to the security officer's computer system S.O. 105′. The reading instructions Instr 235 may be incorporated into a header associated with the identity file Id File 230 or sent as a separate file. In another embodiment of the invention, the actual reading instructions Instr 235′ may be retrieved from the assignee's entity by redirection to a universal resource locator (URL) address included in the security token ST 75 or as part of the identity file Id File 230. A secure messaging arrangement using a secure socket layer or equivalent protocol should be incorporated into the transfer of the reading instructions Instr 235′.

The secure messaging arrangement should utilize the cryptographic resources available from the security token ST 75 to authenticate to the host entity server 120. A simple arrangement would redirect the security officer's computer system S.O. 105′ to the host entity server 120 (e.g., https:entity.worldetc.com) where the actual reading instructions Instr 235′ are then transferred and read by to the security officer's computer system S.O. 105′.

In another embodiment of the invention, instructions lnstr 235 may not be required if the identity file Id File 230 is provided in a standardized image format which is generally recognized and displayed automatically by the computer systems' operating system.

For example, file extensions having *.bmp, *.tif, *.pdf, *.jpg, *.wmf, etc., are automatically recognized by Microsoft Windows operating systems which displays the contents of the file associated with the recognized extension using a preferred graphics application. One skilled in the art will appreciate that other automated arrangements will work as well.

Referring to FIG. 2A, an embodiment of the invention is shown where a valid user who is assigned to the security token ST 75 is required to enter his or her critical security parameter CSP 205 via the user input device 85 for initial identification by the security token ST 75 before the identity file Id File 230 is available for transfer. The valid user hereinafter will be referred to as an assignee. The assignee's critical security parameter CSP 205 is routed to the security token ST 75 where it is compared to a stored reference critical security parameter CSP′ 205′. A successful identification of the assignee causes the transfer of the identity file Id File 230, reading instructions lnstr 235 and the digital certificate Cert 210 to the security officer's computer system S.O. 105′. Depending on the security requirements of the issuing and/or identifying entities, assignee identification is not required in all embodiments.

In a related embodiment of the invention, a digital signature SIG 245 is generated 240 using a private key counterpart Kpub 225 of the public key Kpub 215 associated with the digital certificate Cert 210. This added step provides a greater assurance to the security officer that the identity file Id File 230 is actually being sent from the security token ST 75 and unaltered. One skilled in the art will appreciate that alternative mechanisms, for example, using signed hashed message authentication codes and the like should provide even greater assurances to the security officer.

Referring to FIG. 2B, the identity file Id File 230, reading instructions Instr 235 and the digital certificate Cert 210 are received by the security officer's computer system S.O. 105′. In one embodiment of the invention, the digital certificate Cert 210 is verified using an issuing or associated certificate authority 110. In a related embodiment of the invention, the public key Kpub 215 associated with the digital certificate is used to verify 250 the digital signature SIG 245. If the identity file Id File 230 is provided in a proprietary format, the reading instructions Instr 235 are processed which allows viewing of the contents of the identity file Id File 230 on the display 20 coupled to the security officer's computer system S.O. 105′. Displaying of the contents of the identity file Id File 230 may be conditioned on successful verification of the digital certificate Cert 210, digital signature SIG 245 or both.

Referring to FIG. 2C, an alternate embodiment of the invention is shown where a removable storage unit RSU 50, such as a flash memory device is used as an alternative to a security token, for example, a USB flash memory drive. In this embodiment of the invention, the removable storage unit RSU optionally includes an application App 255 which is transferred along with the identity file Id File 230 and reading instructions Instr 235 to the to the security officer's computer system S.O. 105′. The application App 255 allows proprietary data formats to be utilized for reading the identity file Id File 230.

The application App 255 may be provided as a web browser applet, web browser plug-in module, web browser ActiveX® control or simple utility application. In all embodiments of the invention, the connection between the client computer system 105 and the security officer's computer system S.O. 105′ may be performed over a IEEE 802.x standardized network, in a peer-to-peer relationship 65′ or integrated into a single computer system which combines the functionality of the client computer system 105 and the security officer's computer system S.O. 105′.

In this embodiment of the invention, the reading instructions Instr 235 may be incorporated into the application App 255 directly rather than provided as a separate component. Other than the transfer and execution of the application App 255 to the security officer's computer system S.O. 105′, operation of the invention performs essentially as described in the discussion provided for FIG. 2B.

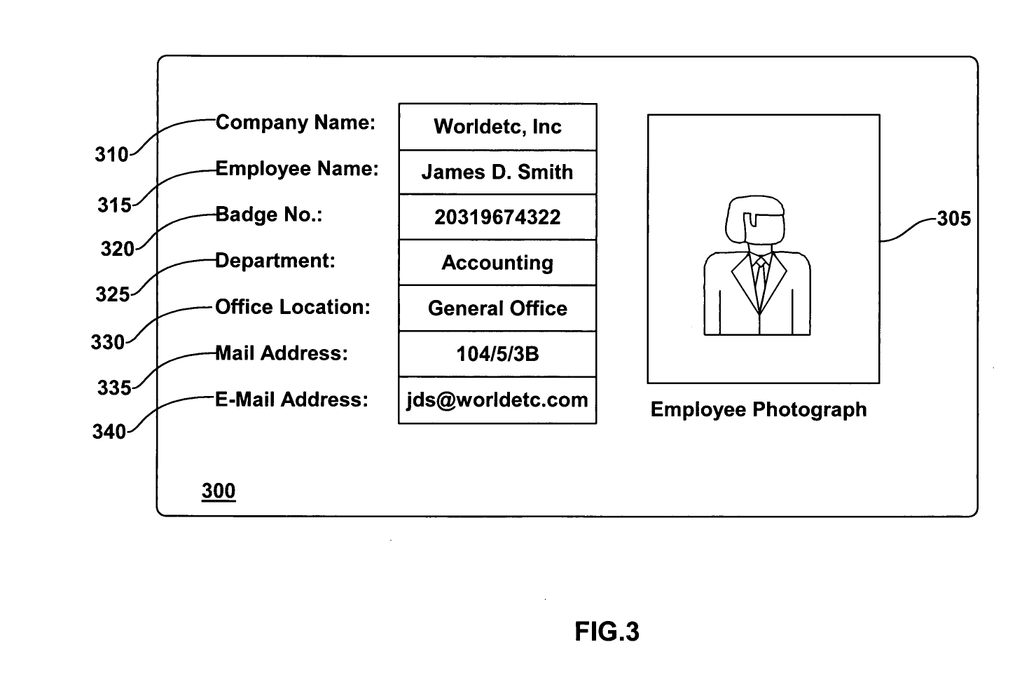

Referring to FIG. 3, the security officer verifies the contents of the identity file Id File 230 with the information and likeness available from the assignee. The information included in the identity file Id File 230 may include an employee photograph 305 and information related to the assignees company name 310, assignee name 315, badge or security token number 320, assignees work group 325, office location 330, physical mailing address 335, electronic mail address 340, company logo, social security number, mother's maiden name and/or other items which may be used to verify the identity of the assignee to the security officer. The security officer may perform the final identity verification at the time assignee presents his or her security badge or thereafter as is desired to meet a particular entity's security policy.

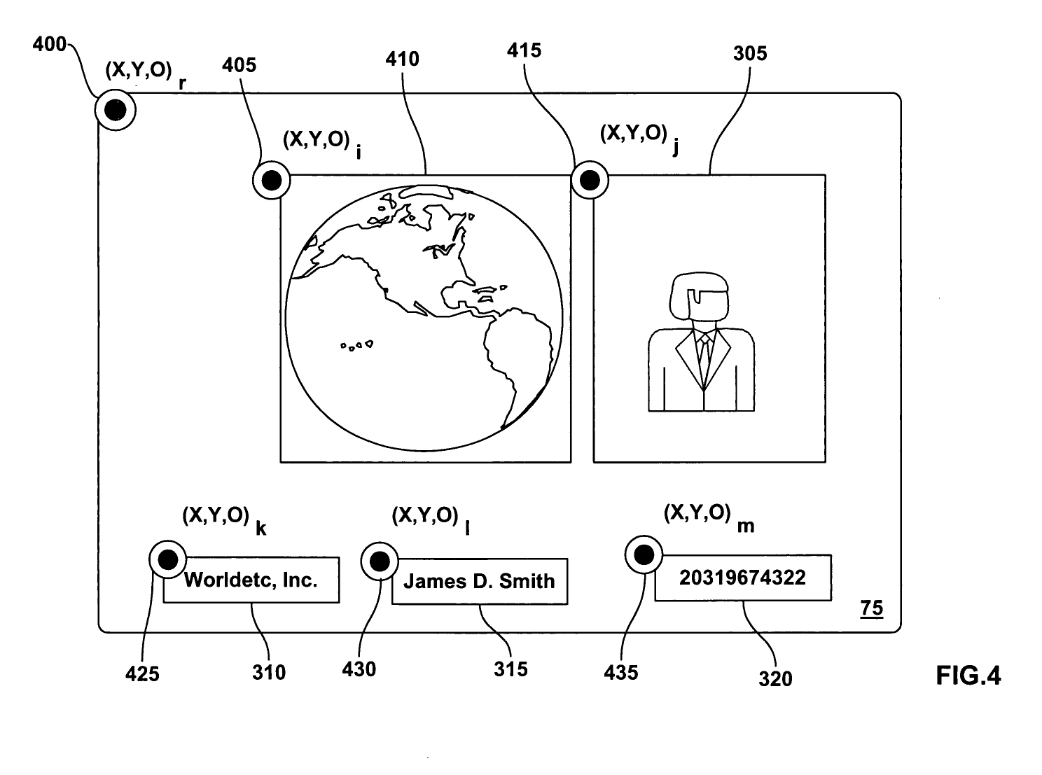

Referring to FIG. 4, the reading instructions should include sufficient instructional information to usefully format and display the contents of the identity file Id File 230 in sufficient detail to allow for the security officer to determine if the layout of the information on the assignee's security badge matches that displayed on the monitor associated with the security computer.

To accomplish the properly formatted display of the security badge 75, a standard reference location is selected (X,Y,O)ᵣ 400 from which the coordinates for placement of the items on the security badge are to be determined. In addition, a separate identifier should be included which provides information related to the type of information displayed such as text labels associated with the company name 310, employee name 315 and badge or employee number 320 or graphic information such as a company logo 410 or employee photograph 305. The type of information conveyed may also include sizing information. An example summary of possible instructional information using standardized rectangular coordinates is provided below in Table 1. The Item refers to the type of information to be displayed for example, reference, graphic, image or text. The Type is an abbreviation of Item where r, g, i, t correspond to the reference, graphic, image or text items respectively. The Coordinates is based on an arbitrary reference point and may use any standardized coordinate system.

The Size refers to the diagonal size of the items and FIG. 4 refers to identifiers provided on FIG. 4. One skilled in the art will appreciate that other coordinate systems and item identifiers could be used in lieu of the examples provided in Table 1 below.

TABLE 1

| Item | Type | Coordinates | Size | |
|---|---|---|---|---|
| Reference | r | 0,0 | 23 | (X,Y,O)ᵣ 400 |
| Graphic | g | 4,−2 | 9.5 | (X,Y,O)ᵢ 405 |
| Image | i | 12,−2 | 8.5 | (X,Y,O)ⱼ 415 |
| Text | t | 1.5,−11 | 4.5 | (X,Y,O)ₖ 425 |
| Text | t | 6.5,−11 | 4.5 | (X,Y,O)ₗ 430 |
| Text | t | 13.5,−11 | 4.5 | (X,Y,O)ₘ 435 |

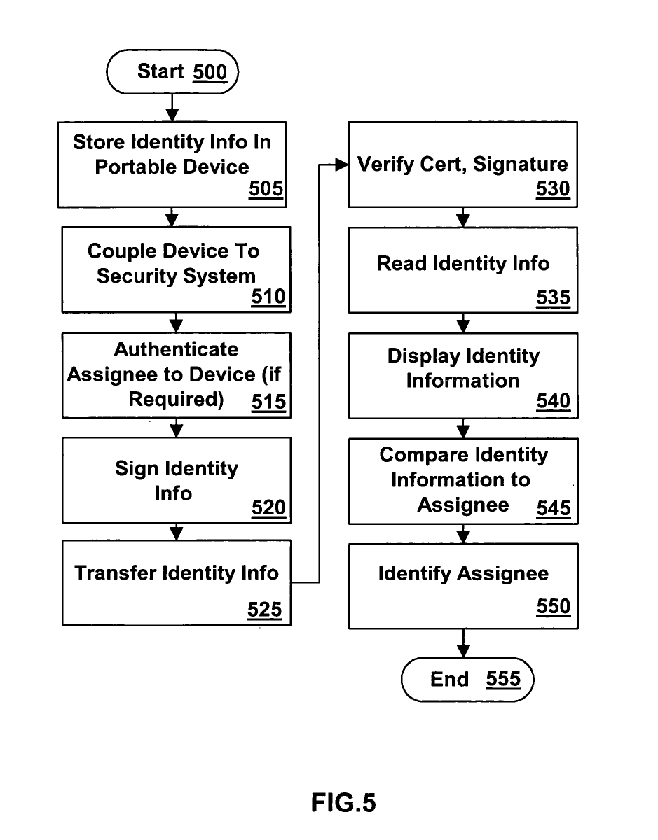

Referring to FIG. 5, a flow chart illustrating the major steps for implementing the various embodiments of the invention is depicted. An identification process is initiated 500 by storing identity information 505 inside a portable device such as a security token or flash memory associated with a security badge. The identity information may include an identify file, reading instructions and an application for reading the identity file. The reading instructions may be omitted if the identity file is stored in a standardized format readily recognizable by an operating system associated with a security system.

Once the identity file information is stored inside the portable device, the portable device is operatively coupled to the security system 510. In one embodiment of the invention, the identity file requires an assignee that is responsible for the security badge/portable device to authenticate to the portable device before the identity information is available for transfer to the security system 515. In most instances, this requires the assignee to provide a critical security parameter, typically a PIN which unlocks the portable device.

In a related embodiment of the invention, a digital signature 520 is generated of the identity information which is transferred to the security system along with the identity information and a digital certificate 525 associated with the portable device.

The security system verifies the digital certificate using a certificate authority and the digital signature, if provided, with a public key associated with the digital certificate 530. The identity information is then read by the security system 535. If the identity file is not provided in a standardized format, the reading instructions are implemented which allow the contents of the identity file to be displayed on a monitor associated with the security system 540. A security officer compares the displayed identity information to the assignee and optionally information imprinted or embossed on his or her security badge 545. The final identity of the assignee is then verified by the security officer 550 which ends the identification process 555.

In the simplest embodiment of the invention, the identity file and if necessary, the reading instructions, are sent to the security system without first authenticating the assignee to the portable device, or providing either the digital certificate or digital signature. The identity file is simply read and directly reviewed by the security officer. However, this simple embodiment of the invention may be vulnerable to a sophisticated attack which provides a fraudulent security token/security badge. One skilled in the art will appreciate that at least some of the security provisions of authenticating the assignee to the portable device, digital signature and digital certificate verifications should be performed to minimize the threat of a fraudulent security token/security badge.

The foregoing described embodiments of the invention are provided as illustrations and descriptions. They are not intended to limit the invention to precise form described.

In particular, it is contemplated that functional implementation of the invention described herein may be implemented equivalently in hardware, software, firmware, and/or other available functional components or building blocks. No specific limitation is intended to a particular security system or financial services system. Other variations and embodiments are possible in light of above teachings, and it is not intended that this Detailed Description limit the scope of invention, but rather by the Claims following herein.

1. A method which permits portable devices associated with security badges and issued by multiple entities to be read by a security system comprising:
storing at least one data file inside a portable device associated with a security badge, wherein said at least one data file provides sufficient information to allow a third party to verify the identity of an assignee of said security badge, and
verifying the identity of said assignee based at least in part on the information included in said at least one data file, wherein the identity of said assignee is verified by said third party without having to rely on a presentation affixed to one or more exterior surfaces of said security badge.

2. The method according to claim 1 wherein said storing further comprises:
operatively coupling said portable device to a security system,
authenticating said assignee to said portable device,
generating a digital signature of said at least one data file using a private key, and
sending said digital signature, said at least one data file and a digital certificate associated with said private key to said portable device.

3. The method according to claim 2 wherein said verifying further comprises:
verifying said digital certificate with a certificate authority associated with said digital certificate, and
verifying said digital signature with a public key included in said digital certificate.

4. The method according to claim 1 wherein said sufficient information comprises a digital photograph of said assignee, said assignee's name, said assignee's employer name, a logo of said employer, a security badge number, a web address or a transferable application.

5. The method according to claim 2 wherein said authenticating is a prerequisite to sending said at least one data file to said security system.

6. The method according to claim 2 wherein said authenticating is accomplished by said assignee inputting a critical security parameter into said portable device via said security system.

7. The method according to claim 1 wherein said sufficient information further comprises executable instructions to permit said security system to at least display the contents of said at least one data file to said third party in a usable format.

8. The method according to claim 7 wherein said verifying of said identity is accomplished by a security officer visually observing said assignee and said displayed contents of said at least one data file.

9. The method according to claim 7 wherein said sufficient information is extrinsic to said at least one data file.

10. The method according to claim 7 wherein said sufficient information is intrinsic to said at least one data file.

11. A method which permits portable devices associated with security badges and issued by multiple entities to be read by a security system comprising:
operatively coupling a portable device associated with a security badge and an assignee to a security system,
providing assignee identity information to said security system,
providing sufficient executable instructions for reading said assignee identity information by said security system to at least display said assignee identity information to a third party in a usable format,
reading said assignee identity information using said provided sufficient instructions, and
visually verifying the identity of said assignee based at least in part on said provided assignee identity information.

12. The method according to claim 11 wherein said assignee identity information comprises a digital photograph of said assignee, said assignee's name, said assignee's employer name, a logo of said employer, a security badge number or a transferable application.

13. The method according to claim 11 further comprising verifying said assignee identity information using a common public key infrastructure transaction.

14. The method according to claim 11 further comprising authenticating said assignee by inputting a critical security parameter into said portable device via said security system.

15. The method according to claim 14 wherein said authenticating is a prerequisite to providing said assignee identity information to said security system.

16. The method according to claim 11 wherein the identity of said assignee is verified by said third party without having to rely on a presentation affixed to one or more exterior surfaces of said security badge.

17. The method according to claim 11 wherein said portable device comprises a flash memory device or a security token.

18. A computer program product embodied in a tangible form readable by at least one processor having executable instructions stored thereon for causing said at least one processor to perform the method of claim 11.

19. The computer program product according to claim 18 wherein said tangible form includes magnetic media, optical media or logical media.

20. The computer program product according to claim 18 wherein said executable instructions are stored in a code format comprising byte code, compiled, interpreted, compliable and interpretable.
